(19) United States
(12) Patent Application Publication
(10) Pub. No.: US 2021/0311562 A1
(43) Pub. Date: Oct. 7, 2021

(54) METHOD AND APPARATUS FOR USE IN CONFIGURING OPTICAL INPUT DEVICE AND RELATED OPTICAL INPUT SYSTEM

(71) Applicant: PixArt Imaging Inc., Hsin-Chu City (TW)

(72) Inventors: Tsung-Fa Wang, Hsin-Chu City (TW); Yen-Min Chang, Hsin-Chu City (TW); Shih-Wei Kuo, Hsin-Chu City (TW)

(73) Assignee: PixArt Imaging Inc., Hsin-Chu City (TW)

(21) Appl. No.: 17/349,944

(22) Filed: Jun. 17, 2021

Related U.S. Application Data
(63) Continuation of application No. 15/613,262, filed on Jun. 4, 2017.

(30) Foreign Application Priority Data
Nov. 11, 2016 (TW) 105136754

(51) Int. Cl. G06F 3/03

(52) U.S. Cl. CPC G06F 3/0304; G06F 3/0317

(57) ABSTRACT

A method for configuring an optical input device is provided. The optical input device includes a movable unit and a sensing device. The movable unit is arranged to move within a predetermined range. The sensing device is arranged to detect a position within the predetermined range at which the movable unit is located. The method includes: adjusting an optical setting of the sensing device to obtain an optimal dynamic range of the sensing device; and configuring a valid input threshold for the optical input device based on the optimal dynamic range.

### CROSS REFERENCE TO RELATED APPLICATIONS

This application is a continuation of U.S. patent application Ser. No. 15/613,262, filed on 2017 Jun. 2004, the disclosure of which is hereby incorporated by reference.

### BACKGROUND OF THE INVENTION

### 1. Field of the Invention

The present invention relates to optical input device, and more particularly to a method of configuring an optical input device, a configuration device, and a related optical input system.

### 2. Description of the Prior Art

Typically, a tactile feel over a keyboard depends on individual characteristics of keys on the keyboard. Since there are minor differences between individual structures of the keys, the user may have an inconsistent tactile feel over the whole keyboard. On the other hand, a pressure of a valid press for each key has been determined and configured before leaving in the factory. The user cannot customize the pressure of the valid press for each key according to his/her favor or habit. In view of this, the conventional keyboards still have some shortcomings.

### SUMMARY OF THE INVENTION

In order to improve existing keyboard products, the present invention provides a configuration device and a related method, which are able to achieve the consistent tactile feel over different keys on the keyboard, and realize customization of tactile responses of the keys.

According to one embodiment of the present invention, a method for operating an optical input system that is adopted to a host is provided. The optical input system includes a plurality of optical input devices, each having a movable unit and a sensing device. The movable unit is arranged to move within a predetermined movement range, and the sensing device being arranged to detect a position within the predetermined movement range at which the movable unit is located to generate a sensed value. The method comprises: receiving, by a driver running on the host, a plurality of sensed values generated by the plurality of optical input device; respectively adjusting an optical setting of the sensing device of each optical input device to obtain an optimal dynamic range of the sensing device of each optical input device; determining a valid input threshold of each optical input device based on the optimal dynamic range; determining, by the driver running on the host, whether a valid press occurs on one of the optical input device based on the sensed value and a valid input threshold corresponding to the one of the optical input device; and performing, by an operating system or an application running on the host, specific operations in response to the valid press. Particularly, the driver running on the host determines at least two valid presses occur on a first optical input device and a second optical input device even if the movable unit of the first input device and the movable unit of the second input device are located at different positions within the predetermined movement range.

According to one embodiment of the present invention, an electronic device is provided. The electronic device comprises an optical input system, a host and a configuration device. The optical input system includes a plurality of optical input devices, each having a movable unit and a sensing device. The movable unit is arranged to move within a predetermined movement range, and the sensing device is arranged to detect a position within the predetermined movement range at which the movable unit is located to generate a sensed value. The host comprises a driver and an application or an operating system. The driver is arranged to receive a plurality of sensed values generated by the plurality of optical input device, and arranged to determine whether a valid press occurs on one of the optical input device based on the sensed value and a valid input threshold corresponding to the one of the optical input device. The application or the operating system is arranged to perform specific operations in response to the valid press. The configuration device comprises: a parameter setting unit, arranged to respectively adjust an optical setting of the sensing device of each optical input device to obtain an optimal dynamic range of the sensing device of each optical input device; and a threshold setting unit, arranged to determine the valid input threshold of each optical input device based on the optimal dynamic range. Particularly, the driver of the host determines at least two valid presses occur on a first optical input device and a second optical input device even if the movable unit of the first input device and the movable unit of the second input device are located at different positions within the predetermined movement range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an application of a configuration device according to one embodiment of the present invention.

FIG. 2 illustrates detailed structure of an optical input device according to one embodiment of the present invention.

FIG. 3 illustrates problems encountered when the sensor is operated with different dynamic ranges.

FIG. 4 illustrates a flow of configuring a light intensity of a light source according to one embodiment of the present invention.

FIG. 5 illustrates a flow of configuring a light sensitivity a sensor according to one embodiment of the present invention.

FIG. 6 illustrates a flow of a method for configuring an optical input device according to one embodiment of the present invention.

FIG. 7 illustrates how the inventive method performs a batch configuration for a keyboard device.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

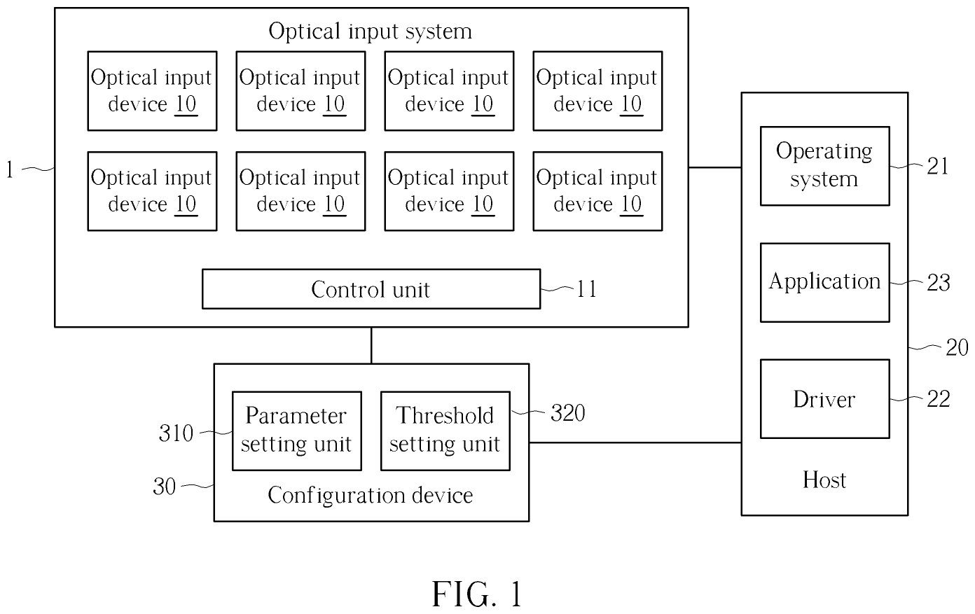

According to one embodiment, a configuration device is provided. A possible application of the configuration device is illustrated in FIG. 1. As illustrated, an optical input system 1 includes a plurality of optical input devices 10. Each optical input device 10 generates a sensed value based on a press by a user, and sensed values will be sent to a host 20 (or a control unit 11). An operating system 21, an application 23 and a driver 22 are running on the host 20. When the driver 22 (or the control unit 11) receives one or more sensed values generated by the one or more optical input devices 10 and judges the sensed values satisfy thresholds corresponding to a valid press, it sends a message to the operating system 21 to indicate the valid press. The operating system 21 and the application 23 will perform corresponding operations in response to the valid press. For making the user have consistent tactile feel when using the optical input system 1, the configuration device 30 provides individual configuration for each optical input device 10. The configuration device 30 comprises a parameter setting unit 310 and a threshold setting unit 320. Please note that each component in the configuration device 30 could be implemented with software or/and hardware that is/are separate from the optical input system 1 and the host 20. Alternatively, each component in the configuration device 30 could be implemented with collective operations performed by the hardware in the optical input system 1 (e.g. the control unit 11) and the program running on the host 20 (e.g. driver 22). In one embodiment, the optical input system 1 could be a keyboard, while the optical input devices 10 could be keys on the keyboard.

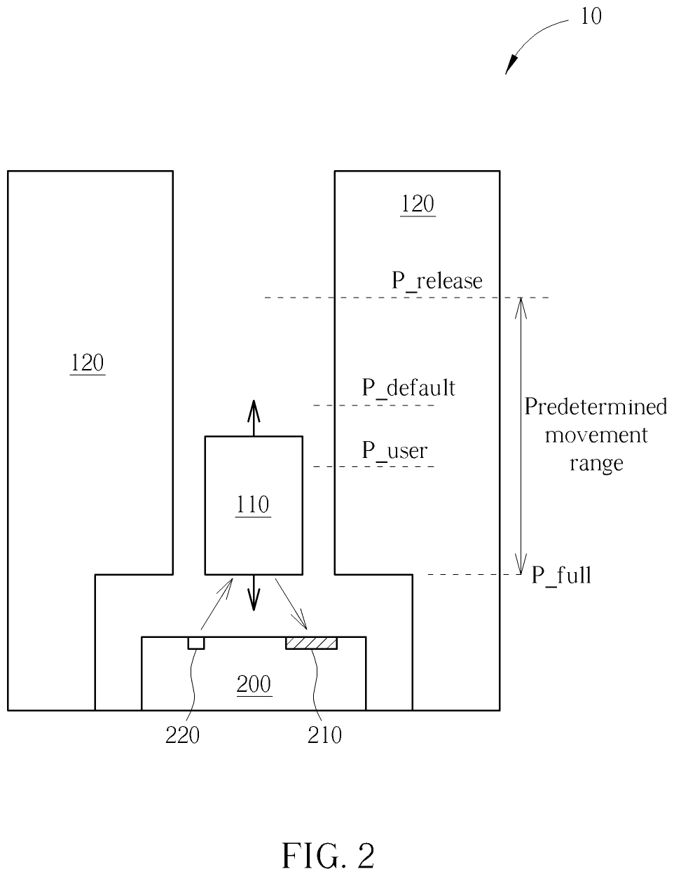

Detailed structure of one of optical input devices 10 is illustrated in FIG. 2 according to one embodiment of the present invention. As illustrated, the optical input device 10 includes a movable unit 110, a hollow base 120 and a sensing device 200. The movable unit 110 is operable to move along the hollow base 120 in a substantially vertical direction within a predetermined movement range. Furthermore, the movable unit 110 is coupled to the hollow base 120 through a spring (not shown). When the pressure is released, the movable unit 110 can return to its initial position. The sensing device 200 includes a sensor 210 and a light source 220. The light source 220 emits the light onto the bottom of the movable unit 110. Reflected light is formed and received by the sensor 210 after the light is emitted. Depending on the intensity of the reflected light, the sensor 210 produces a corresponding sensed value LOD_Value. The intensity of the reflected light (or the amount of the sensed value LOD_Value) is substantially inversely proportional to the distance between the movable unit 110 and the light source 220. The driver 22 (or the control unit 11 in the optical input system 1) compares a valid input threshold LOD_Value_Threshold with the obtained sensed value LOD_Value. When the sensed value LOD_Value is greater than or equal to the valid input threshold LOD_Value_Threshold, it notifies the operating system 21 that the user's press is valid.

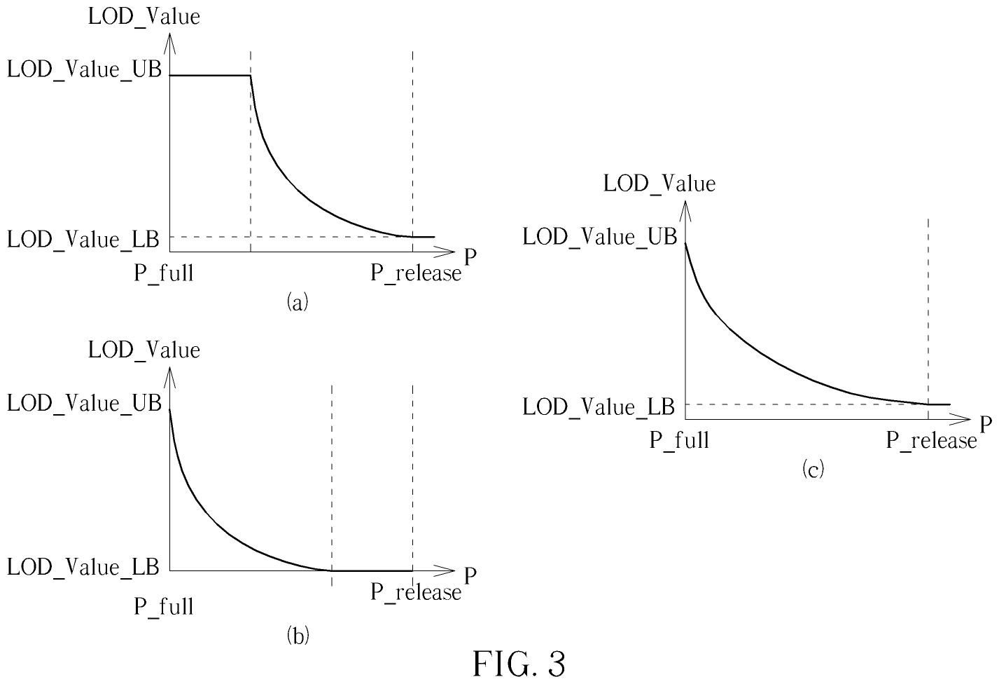

There are two stages in the configuration performed by the configuration device 30 of the present invention. A first stage of the configuration is to adjust optical settings of the sensing device 200 to have the sensing device 200 operated within an optimal dynamic range. The dynamic range of the sensing device 200 is affected by a light intensity of the light source 220 and a light sensitivity of the sensor 210. FIG. 3 illustrates correspondences between positions P of the movable unit 110 and the sensed values LOD_Value when the sensing device 200 is operated within different dynamic ranges. The part (a) of FIG. 3 illustrates a situation that before the movable unit 110 is moved to the extreme position P_full (i.e., the user presses the key to the end), the sensed value LOD_Value has been saturated. On the other hand, the part (b) of FIG. 3 illustrates a situation that before the movable unit 110 is moved to a release position P_release (the user releases the key), no sensed value LOD_Value can be detected. In view of above, poor optical setting of the sensing device 200 may lead to the narrower dynamic range, which limits a travel distance of the optical input device 10. A better dynamic range should look like the curve illustrated by the part (c) of FIG. 3.

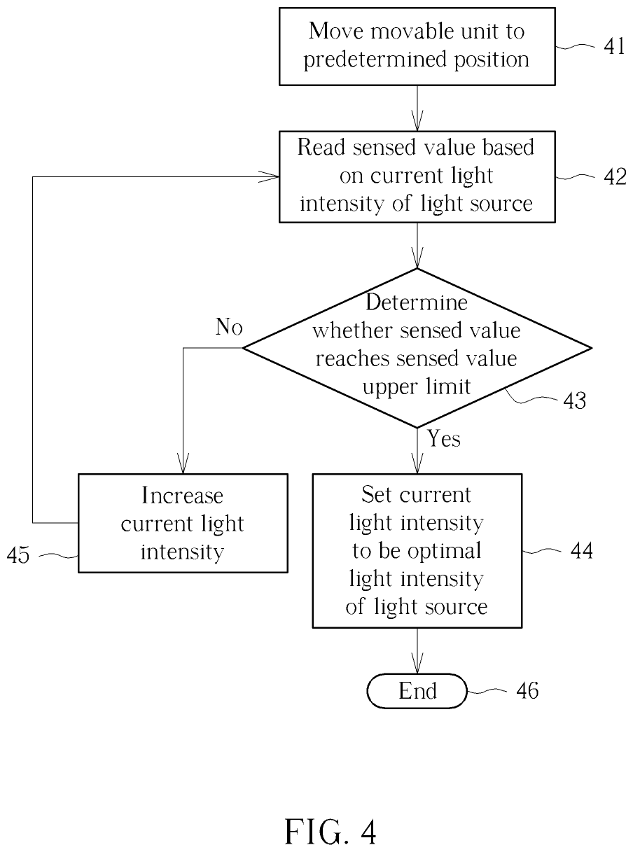

When determining the dynamic range, the parameter setting unit 310 in the configuration device 30 needs to configure the light intensity of the light source 220 first. Please refer to the flow regarding configuring the light intensity as illustrated in FIG. 4. At step 41, the movable unit 110 is moved to a predetermined position (which can be achieved by using a jig in a factory test). For example, the movable unit 110 could be moved to the position P_full or around the position P_full. At step 42, based on a current light intensity of the light source 220, a sensed value LOD_Value is read. At step 43, it is determined whether the sensed value LOD_Valuer reaches a sensed value upper limit LOD_Value_UB. If yes, the flow goes to step 44, setting the current light intensity of the light source 220 to be an optimal light intensity of the light source 220 and stopping the flow; otherwise, the flow goes to step 45, increasing the current light intensity of the light source 220 and returning back to step 42. Based on the increased light intensity, the sensed value LOD_Value is read again and accordingly entering step 43, determining whether the sensed value LOD_Valuer reaches the sensed value upper limit LOD_Value_UB. Steps 42, 43 and 45 will be repeated until the sensed value LOD_Value has reached the sensed value upper limit LOD_Value_UB.

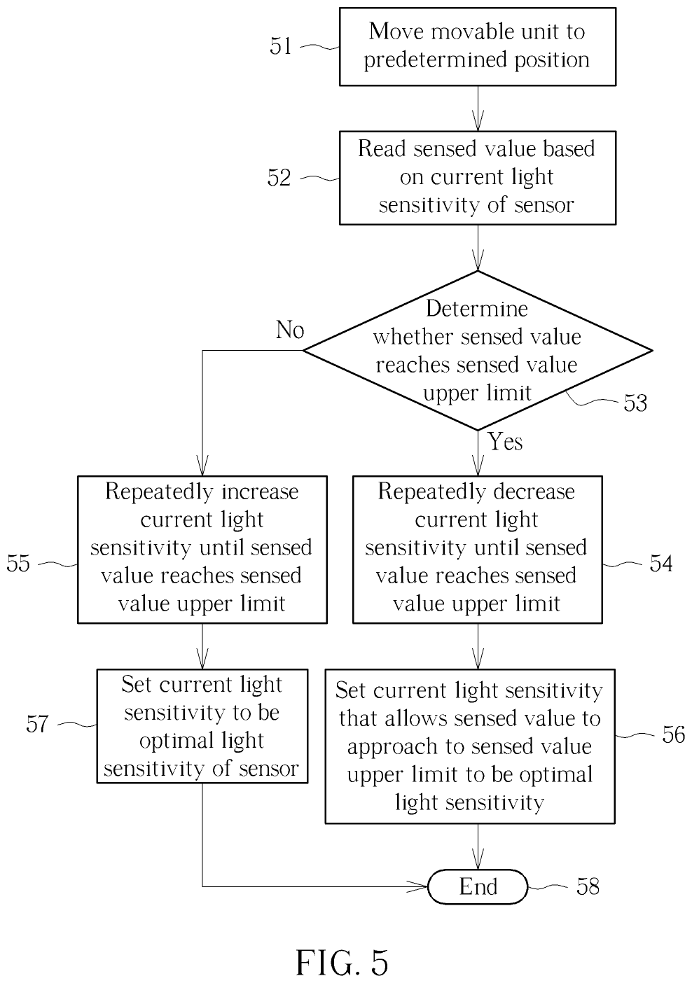

After configuring the light intensity of the light source 220 by the above-mentioned flow, the light source 220 will be operated with the obtained optimal light intensity. Afterwards, the parameter setting unit 310 starts to configure the light sensitivity of the sensor 210. The light sensitivity of the sensor 210 represents the sensor 210's sensitivity to the received reflected light. For a fixed light intensity, the higher the light sensitivity, the greater the sensed value LOD_Value will be. FIG. 5 illustrates a flow of configuring the light sensitivity according to one embodiment of the present invention. At step 51, the movable unit 110 is again moved to the position P_full or around the position P_full. At step 52, based on a current light sensitivity of the sensor 210, a sensed value LOD_Value is read. At step 53, it is determined whether the sensed value LOD_Value reaches the sensed value upper limit LOD_Value_UB. If yes, the flow goes to step 54; otherwise, the flow goes to step 55. At step 54, repeatedly decreasing the current light sensitivity LOD_Sensitivity of the sensor 210 until the sensed value LOD_Value is lower than the sensed value upper limit LOD_Value_UB. Then, the flow goes to step 56, the current light sensitivity LOD_Sensitivity that allows the sensed value LOD_Value to approach to (be very close to) the sensed value upper limit LOD_Value_UB is set to be the optimal light sensitivity LOD_Sensitivity_optimal of the sensor 210 and the flow is therefore ended. On the other hand, when the flow goes to step 55, the current light sensitivity LOD_Sensitivity of the sensor 210 is repeatedly increased until the sensed value LOD_Value reaches the sensed value upper limit LOD_Value_UB. Then, the flow goes to step 57, setting the current light intensity LOD_Sensitivity to be the optimal light sensitivity LOD_Sensitivity_optimal of the sensor 210 and accordingly ending the flow. The intended purposes of step 56 and 57 are to obtain the optimal light sensitivity LOD_Sensitivity_optimal that is able to make the sensed value LOD_Value exactly equal to the sensed value upper limit LOD_Value_UB when the movable unit 110 is located at the position P_full. In other words, if the light sensitivity is lower than the optimal light sensitivity LOD_Sensitivity_optimal, the sensed value LOD_Value hardly reaches the upper limit even if the movable unit 110 has been located at the extreme position P_full. If the light sensitivity is higher than the optimal light sensitivityLOD_Sensitivity_optimal, the sensed value LOD_Value will be saturated before the movable unit 110 is moved to the extreme position P_full. Both situations limit the dynamic range of the sensing device 200. Therefore, it is necessary to configure the light sensitivity of the sensor 210 with the optimal light sensitivity LOD_Sensitivity_optimal such that the sensing device 200 can be guaranteed to be operated within a wider dynamic range.

After the light sensitivity and light intensity configuration, the optimal light intensity LED_intensity_optimal of the light source 220 and the light sensitivity LOD_Sensitivity_optimal of the sensor 210 can be set, which leads to the optimal dynamic range of the sensing device 200. Accordingly, the configuration device 30 determines a correspondence between the sensed values LOD_Value and the positions of the movable unit 110 and also determines a valid input threshold LOD_Threshold for identifying user's valid press based on the optimal dynamic range. The threshold setting unit 320 in the configuration device 30 records sensed values LOD_Value that are obtained by the sensor 210 when the movable unit 110 is moved from the release position P_release to the extreme position P_full, thereby obtaining the correspondence. Such correspondence specifies the sensed value upper limit LOD_Value_UB with respect to the movable unit 110 at the extreme position P_full, the sensed value lower limit LOD_Value_LB with respect to the movable unit 110 at the release position P_release, and sensed values LOD_Value with respect to each position between the release position P_release and the extreme position P_full. The above-mentioned correspondence may be similar to the curve illustrated in part (c) of FIG. 3. The configuration device 30 determines the valid input threshold LOD_Threshold for the optical input device 10 according to the optical input device 10's correspondence in the follow ways.

For guaranteeing each optical input device 10 has same response when being pressed. In a factor test, a jig is used to press each optical input device 10 with identical pressure. That is, each movable unit 110 of the optical input devices 10 are moved to a same position (e.g. the position P_default). Then, the threshold setting unit 320 sets the sensed values LOD_Value that are respectively read from each optical input device 10 (; these values may not be identical because the optical input devices 10 may have difference in their characteristics/structures) to be the valid input threshold LOD_Threshold for each optical input device 10. Accordingly, the driver 22 or the control unit 11 of the optical input system 1 is configured with the valid input threshold LOD_Threshold. Alternatively, the threshold setting unit 320 may refer to the correspondence of each optical input device 10 to derive a sensed value LOD_Value for each movable unit 110 at the same position P_default and accordingly configures the valid input threshold LOD_Threshold with the sensed value LOD_Value derived from the correspondence of each optical input device 10. In such case, the threshold setting unit 320 does not need to read sensed values LOD_Value generated by the sensors 210 and the jig can be omitted. Instead, a specific press distance is directly selected to achieve the consistency of the tactile responses of the optical input devices 10.

Furthermore, the configuration device 30 may provide a configuration interface for the user (in conjunction with operations performed by the host 20) for setting the valid input threshold LOD_Threshold. The configuration interface may notify the user to press one or more movable unit 110 with user's habitual pressure, such as, to the position P_user. Accordingly, the threshold setting unit 320 sets the sensed value LOD_Value that is currently read to be the valid input threshold LOD_Threshold and accordingly configures the driver 22 or the control unit 11 of the optical input system 1.

In addition to the user's actual press to determine the valid press threshold, the present invention also provides a smart configuration. That is, the threshold setting unit 320 can divide the correspondence of each optical input device 10 into multiple steps. By providing a configuration interface (in conjunction with operations performed by the host 20) to the user, the user is asked to select one of multiple pressure levels (from heavy to light). According to user's selected pressure level, the threshold setting unit 320 finds out a corresponding step and a corresponding sensed value LOD_Value for each optical input device 10, thereby to determine the valid input threshold LOD_Threshold and configure the driver 22 or the control unit 11 of the optical input system 1.

In addition to above-mentioned ways, the present invention can also configure the optical input device in a machine learning way. That is, the threshold setting unit 320 records positions that one or more movable unit 110 have ever located in the user's daily uses, thereby finding out user's habitual pressure. The threshold setting unit 320, based on an average value, a maximum value and/or a minimum value of the recorded positions, to determine a proper sensed value LOD_Value (by referring to the correspondence). Accordingly, the previously determined valid input threshold LOD_Threshold could be replaced or fixed. Such way can satisfy user's habitual pressure more precisely.

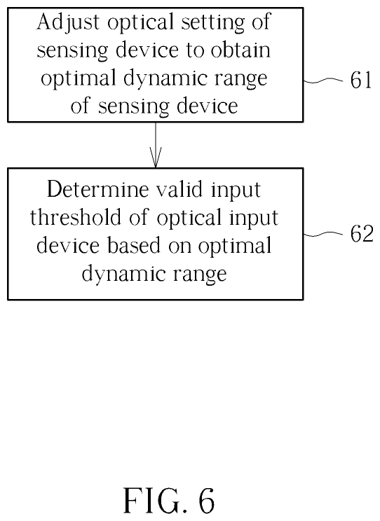

Please refer to FIG. 6, which illustrates a flow regarding operations performed by the configuration device 30 according to one embodiment of the present invention. At step 61, the optical setting of the sensing device is adjusted to obtain the optimal dynamic range of the sensing device. At step 62, the valid input threshold corresponding to the optical input device is determined based on the optimal dynamic range. Please note that the flow depicted by FIG. 6 can apply to one, more or all optical input devices 10 in the optical input system 1.

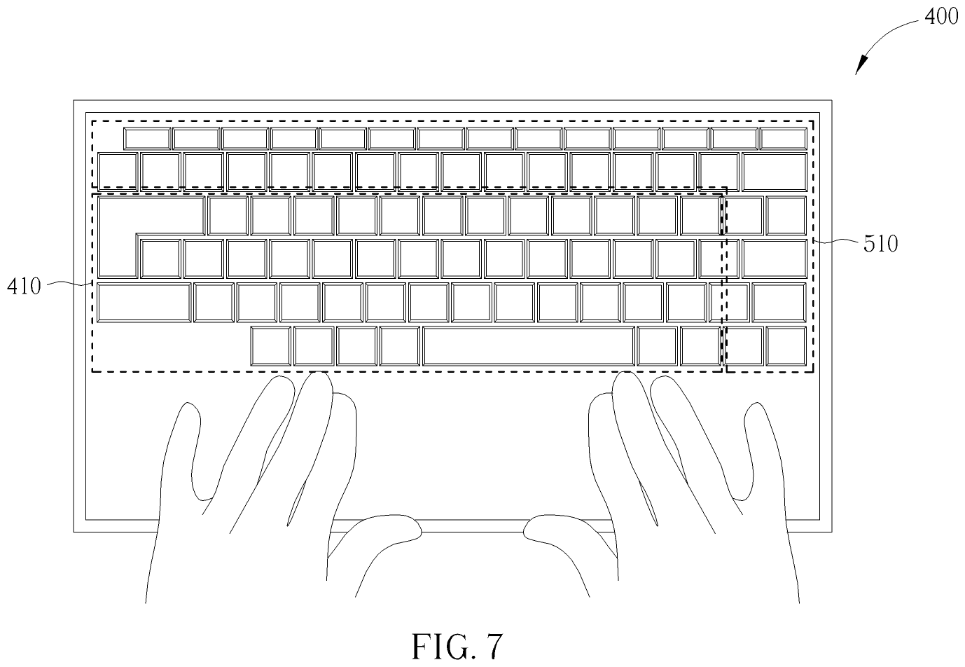

When the optical input system 1 is a keyboard and the optical input device 10 are keys on the keyboard. The configuration can be performed in a batch way to improve the efficiency. As illustrated by FIG. 7, the keyboard 400 corresponds to the optical input system 1, and each key on the keyboard 400 corresponds to the optical input device 10. In this case, the configuration device 30 sets different valid input thresholds LOD_Threshold for presses occurring in different regions. Specifically, a user may use different fingers to press keys in the different regions of the keyboard 400. Usually, the user uses index finger, middle finger, and thumb to press the keys in the center region 410 of the keyboard 400. As these fingers causes heavier pressures on the keys, the threshold setting unit 320 could set the valid press for keys in the center region 410 of the keyboard 400 corresponds to higher valid input thresholds LOD_Threshold. On the other hand, the threshold setting unit 320 could set the valid press for keys in the edge region 510 of the keyboard 400 corresponds to lower valid input thresholds LOD_Threshold because the user uses other finger with lighter pressures on the keys in the edge region 510. With the batch configuration, valid input threshold setting of multiple keys can be simultaneously performed and finished, which improves the efficiency significantly.

In conclusion, the present invention adjusts the optical setting for the sensing device to obtain the optimal dynamic range for each optical input device. As such, the consistent tactile feel can be realized (; if some optical input devices have more differences in their structures than others, these optical input devices may have different dynamic ranges, which makes it difficult to achieve the consistent tactile feel. For example, the intended press distance does not fall within the dynamic range of these optical input devices, and the tactile responses of these optical input devices will be quite different from others). Furthermore, the present invention also provides various ways of configuring the valid input threshold. For example, the configuration for the consistent tactile feel, the configuration for providing user customization, the configuration for learning user's habit, and the batch configuration. All these different configurations can effectively improve the user experience.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

An embodiment of the invention may include functionality that may be implemented as software executed by a processor, hardware circuits or structures, or a combination of both. The processor may be a general-purpose or dedicated processor. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for operating an optical input system adopted to a host, the optical input system including a plurality of optical input devices, each having a movable unit and a sensing device, the movable unit being arranged to move within a predetermined movement range, the sensing device being arranged to detect a position within the predetermined movement range at which the movable unit is located to generate a sensed value, the method comprising:
receiving, by a driver running on the host, a plurality of sensed values generated by the plurality of optical input device;
respectively adjusting an optical setting of the sensing device of each optical input device to obtain an optimal dynamic range of the sensing device of each optical input device;
determining a valid input threshold of each optical input device based on the optimal dynamic range;
determining, by the driver running on the host, whether a valid press occurs on one of the optical input device based on the sensed value and a valid input threshold corresponding to the one of the optical input device; and
performing, by an operating system or an application running on the host, specific operations in response to the valid press;
wherein the driver running on the host determines at least two valid presses occur on a first optical input device and a second optical input device even if the movable unit of the first input device and the movable unit of the second input device are located at different positions within the predetermined movement range.

2. The method of claim 1, wherein the step of adjusting the optical setting comprises:
determining an optimal light intensity corresponding to a light source of the sensing device according to a sensed value that is obtained when the movable unit is located at a specific position.

3. The method of claim 2, wherein the step of determining the optimal light intensity comprises:
obtaining the sensed value based on a current light intensity of the light source;
determining whether the sensed value is equal to a sensed value upper limit;
setting the current light intensity to be the optimal light intensity when the sensed value is equal to the sensed value upper limit; and
increasing the current light intensity when the sensed value is lower than the sensed value upper limit.

4. The method of claim 1, wherein the step of adjusting the optical setting of the sensing device comprises:
determining an optimal light sensitivity corresponding to a sensor of the sensing device according to a sensed value that is obtained when the movable unit is located at a specific position.

5. The method of claim 4, wherein the step of determining the optimal light sensitivity comprises:
obtaining the sensed value based on a current light sensitivity of the sensor;
comparing the sensed value with a sensed value upper limit;
decreasing the current light sensitivity when the sensed value is equal to the sensed value upper limit; and
increasing the current light sensitivity when the sensed value is lower than the sensed value upper limit.

6. The method of claim 1, wherein the step of determining the valid input threshold corresponding to the optical input device comprises:
setting a sensed value to be the valid input threshold, wherein the sensed value is obtained when the movable unit is located at a specific position within the predetermined movement range.

7. The method of claim 1, wherein the step of determining the valid input threshold corresponding to the optical input device comprises:
determining a sensed value upper limit and a sensed value lower limit of the optimal dynamic range; and
determining a correspondence between each sensed value and each position of the movable unit within the predetermined movement range.

8. The method of claim 7, wherein the step of determining the valid input threshold corresponding to the optical input device comprises:
referring to the correspondence to obtain a specific sensed value corresponding to a specific position of the movable unit within the predetermined movement range; and
configuring the valid input threshold according to the specific sensed value.

9. The method of claim 7, wherein the step of determining the valid input threshold corresponding to the optical input device comprises:
recording a plurality of stop positions of the movable unit;
determining a common position based on the plurality of stop positions;
referring to the correspondence to obtain a specific sensed value corresponding to the common position; and
configuring the valid input threshold according to the specific sensed value.

10. An electronic device, comprising:
an optical input system, including a plurality of optical input devices, each having a movable unit and a sensing device, wherein the movable unit is arranged to move within a predetermined movement range, and the sensing device is arranged to detect a position within the predetermined movement range at which the movable unit is located to generate a sensed value;
a host, comprising:
a driver, arranged to receive a plurality of sensed values generated by the plurality of optical input device, and arranged to determine whether a valid press occurs on one of the optical input device based on the sensed value and a valid input threshold corresponding to the one of the optical input device; and
an operating system or an application, arranged to perform specific operations in response to the valid press; and
a configuration device, comprising:
a parameter setting unit, arranged to respectively adjust an optical setting of the sensing device of each optical input device to obtain an optimal dynamic range of the sensing device of each optical input device; and
a threshold setting unit, arranged to determine the valid input threshold of each optical input device based on the optimal dynamic range;
wherein the driver of the host determines at least two valid presses occur on a first optical input device and a second optical input device even if the movable unit of the first input device and the movable unit of the second input device are located at different positions within the predetermined movement range.

11. The electronic device of claim 10, wherein the parameter setting unit is arranged to:
determine an optimal light intensity corresponding to a light source of the sensing device according to a sensed value that is obtained when the movable unit is located at a specific position.

12. The electronic device of claim 11, wherein the parameter setting unit is arranged to:
obtain the sensed value based on a current light intensity of the light source;
determine whether the sensed value is equal to a sensed value upper limit;
set the current light intensity to be the optimal light intensity when the sensed value is equal to the sensed value upper limit; and
increase the current light intensity when the sensed value is lower than the sensed value upper limit.

13. The electronic device of claim 10, wherein the parameter setting unit is arranged to:
determine an optimal light sensitivity corresponding to a sensor of the sensing device according to a sensed value that is obtained when the movable unit is located at a specific position.

14. The electronic device of claim 13, wherein the parameter setting unit is arranged to:
obtain the sensed value based on a current light sensitivity of the sensor;
compare the sensed value with a sensed value upper limit;
decrease the current light sensitivity when the sensed value is equal to the sensed value upper limit; and
increase the current light sensitivity when the sensed value is lower than the sensed value upper limit.

15. The electronic device of claim 10, wherein the threshold setting unit is arranged to:
set a sensed value to be the valid input threshold, wherein the sensed value is obtained when the movable unit is located at a specific position within the predetermined movement range.

16. The electronic device of claim 10, wherein the threshold setting unit is arranged to:
determine a sensed value upper limit and a sensed value lower limit of the optimal dynamic range; and
determine a correspondence between each sensed value and each position of the movable unit within the predetermined movement range.

17. The electronic device of claim 16, wherein the threshold setting unit is arranged to:
refer to the correspondence to obtain a specific sensed value corresponding to a specific position of the movable unit within the predetermined movement range; and
configure the valid input threshold according to the specific sensed value.

18. The electronic device of claim 16, wherein the threshold setting unit is arranged to:
record a plurality of stop positions of the movable unit;
determine a common position based on the plurality of stop positions;
refer to the correspondence to obtain a specific sensed value corresponding to the common position; and
configure the valid input threshold according to the specific sensed value.
